(19) United States
(12) Patent Application Publication
(10) Pub. No.: US 2006/0059049 A1
(43) Pub. Date: Mar. 16, 2006

(54) Method and system for providing a path through a store to items associated with a task

(76) Inventors: Robert P. Morris, Raleigh, NC (US); Joseph Fobert, Chapel Hill, NC (US)

Correspondence Address: IPAC, 111 Corning Road, Suite 220, Cary, NC, 27511, US

(21) Appl. No.: 10/942,492

(22) Filed: Sep. 16, 2004

(51) Int. Cl. G06Q 30/00; G07F 7/00

(52) U.S. Cl. 705/26; 705/27

(57) ABSTRACT

The present invention is related to a computer system that provides a path through at least one store to items associated with a task. Aspects of the present invention include defining a route criteria that identifies other products that may be of interest to a shopper, determining where in the store the items are located, and generating the path based on the location of the items and on the route criteria. In this manner, the path leads the shopper to each of the at least one items and past other products of interest.

### FIELD OF INVENTION

The present invention relates to computer systems, and more particularly to utilizing a computer system to provide a path through a store to one or more items associated with a task.

### BACKGROUND OF THE INVENTION

Computer products are currently utilized by retail stores to assist shoppers in locating merchandise in a store and retrieving product information. For example, a shopper can enter a product descriptor, e.g., the product number or name, into a stationary or portable computing device at a store and the computing device displays information about the product and/or where the product is located. In some instances, a map is displayed to the shopper that graphically illustrates a path the shopper can follow to reach the location of the product.

Computer products are also available for a user's personal computer that allow the shopper to submit a shopping list, e.g., a grocery list, and then display the location of each item on the list and/or a map showing the physical locations of the items in a grocery store. Some home computer products allow the shopper to select a recipe from a list of recipes, and the items needed to make the recipe are automatically displayed and located on a map of a grocery store.

Such computer products assist the shopper by reducing the time needed to locate the desired items in a store. Nevertheless, the path generated by the computer products generally does not take into account factors other than a starting point and a destination point, i.e., the location of the item. For example, the path generated does not consider the location of other products that might be of interest to the shopper, such as discounted items, products related to an item, substitute or equivalent items, or products bought by the shopper during previous visits. Thus, an opportunity for the store to increase its sales by exposing the shopper to other products is squandered.

Accordingly, what is needed is a method and system for providing a path through a store that leads a shopper to one or more items associated with a task as well as other items that might be of interest. The present invention addresses such a need.

### BRIEF SUMMARY OF THE INVENTION

The present invention provides a method and system for providing a path through at least one store to one or more items associated with a task. Aspects of the present invention include defining a route criteria that identifies other products that may be of interest to a shopper, determining where in the store the items are located, and generating the path based on the location of the items and on the route criteria. Accordingly, the path leads the shopper to each location associated with each of the at least one items associated with the task and past the other items of interest satisfying the route criteria.

In another aspect of the present invention, a map is displayed to the shopper that shows a store layout and the path, which begins at a starting point and leads to at least one item associated with the task. Along the path, the location of the other items of interest are indicated so that the shopper can peruse and select those items on the shopper's way to the item associated with the task. Thus, the path can serve multiple purposes, such as exposing the shopper to sale merchandise and to accessory items, in addition to directing the shopper to the one or more items associated with the task.

In another aspect of the present invention, the path directs the shopper to one or more different stores if an item associated with the task is not available in the present store, but available in the one or more different stores. Here, the map provides directions to the one or more different stores.

### BRIEF DESCRIPTION OF SEVERAL VIEWS OF THE DRAWINGS

FIG. 1 is a system diagram illustrating a store according to a preferred embodiment of the present invention.

FIG. 2 is a flowchart illustrating a process for generating a path through a store to at least one item according to a preferred embodiment of the present invention.

FIG. 3 is an exemplary window through which the shopper specifies the task according to a preferred embodiment of the present invention.

FIG. 4 is an exemplary diagram of the map displayed to the shopper according to a preferred embodiment of the present invention.

FIG. 5 is a flowchart illustrating a process for managing an item that is unavailable in a store according to a preferred embodiment of the present invention.

FIG. 6 is a block diagram illustrating a network environment according to this preferred embodiment of the present invention.

### DETAILED DESCRIPTION OF THE INVENTION

The present invention relates to computer systems, and more particularly to utilizing a computer system to provide a path through a store to one or more items associated with a task. The following description is presented to enable one of ordinary skill in the art to make and use the invention and is provided in the context of a patent application and its requirements. Various modifications to the preferred embodiments and the generic principles and features described herein will be readily apparent to those skilled in the art. For example, although the preferred embodiment is in the context of a portable wireless computing device linked to a server over a wireless network, the same principles can be applied to a stationary terminal coupled to the server over a wired network. Thus, the present invention is not intended to be limited to the embodiments shown but is to be accorded the widest scope consistent with the principles and features described herein.

According to the method and system of the present invention, a shopper utilizes an electronic device in a store to specify a task the shopper wishes to perform. In response, the task is mapped to at least one list of items required to complete the task, and a path is generated that identifies each item on the list and its location in the store. Unlike current systems, the shopper is not required to create a shopping list because the system of the present invention automatically provides such a list when the shopper chooses the task. This is particularly helpful if the shopper does not know what items are required to perform the task. Moreover, the items on the list may correspond to any type of task, not just to a recipe. Finally, the path generated by the system of the present invention also identifies other products that may be of interest to the shopper and that are located along the path. Accordingly, the path of the present invention is based not only on the store layout and the location of the items associated with the task, but also on other independent factors or criteria, such as, for example, the shopper's historical purchasing patterns, the store's inventory, the location of related items, accessory or alternative items, and sale items.

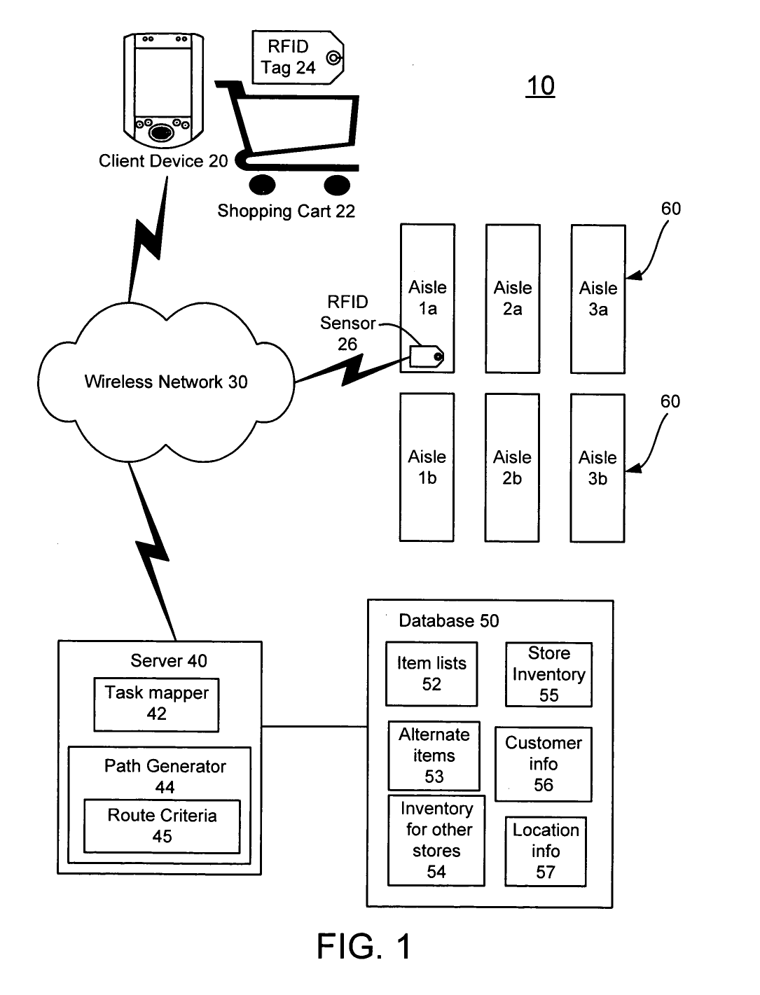

FIG. 1 is a block diagram of a store environment according to a preferred embodiment of the present invention. The store 10 includes a plurality of aisles 60, and a server 40 coupled to a database 50. The shopper has access to a client device 20, which communicates with the server 40 over a wireless network 30. Preferably, the client device 20 is a mobile portable electronic device that can be easily carried throughout the store 10 by the shopper. The client device 20 can be provided by the store 10 or can be a device owned by the shopper, e.g., a mobile phone, PDA or the like. In one embodiment, the client device 20 is attachable to a shopping cart 22. Alternatively, the client device 20 can be a stationary device positioned at various locations in the store 10.

In either case, the client device 20 allows the shopper to specify an item the shopper would like to purchase or a task the shopper would like to perform. The task can be of any type, e.g., tiling a bathroom, networking computers in an office, baking a cake, etc. The task can also define certain categories of items, such as all discounted items, yoga related items, etc. By allowing the shopper to specify the task, the shopper is not required to know beforehand what items are needed to perform the task. In addition, even if the shopper knows what items are needed, the present invention eliminates the chances of forgetting an item.

As stated above, the client device 20 communicates with the server 40 via the wireless network 30. According to the present invention, the server 40 includes a task mapper 42 and a path generator 44. The task mapper 42 is used to map a specified task to one or more lists 52 of required items to perform the task. Depending on the task, more than one item list 52 may be provided to take into account factors that affect item choices. Such factors include the shopper's budget and skill level. In a preferred embodiment, the task mapper 42 receives the specified task from the client device 20 and retrieves the one or more associated item lists 52 from the database 50.

The task mapper 42 then transmits the one or more item lists 52 to the path generator 44, which creates a path through the store 10 to each of the items on an item list 52. The path can be to specific items on the list 52 or the path can incorporate each item on the list 52.

In a preferred embodiment, the path generator 44 includes route criteria 45 that define other products that might interest the shopper. In a preferred embodiment, the route criteria 45 is configurable either by a store administrator or alternatively by the shopper.

Through the route criteria 45, the path generator 44 can be directed to incorporate various parameters that may or may not be related to the task or to the items on the list 52. For example, the route criteria 45 can direct the path generator 44 to consider historical product purchasing patterns of the shopper, demographic information, store inventory, discounted items, and the location of accessories or alternate items. Thus, the path created by the path generator 44 can intentionally expose the shopper to other products of interest while leading the shopper to the items on the list 52.

By utilizing the route criteria 45 in this manner, the path generator 44 creates a path that can serve multiple purposes simultaneously. While the path's primary purpose is to guide the shopper to the items on the item list 52, it can also direct the shopper to ancillary products related or unrelated to the task or to products the store wishes to promote.

The database 50 stores the information necessary for the task mapper 42 and the path generator 44 to perform their respective functions. The stored information includes the item lists 52, alternate items 53 for items on the item lists 52, an inventory of products in different stores 54, the store's 10 inventory of products 55, information related to shoppers 56 including past purchases, and location information 57 associated with the items on the item lists 52.

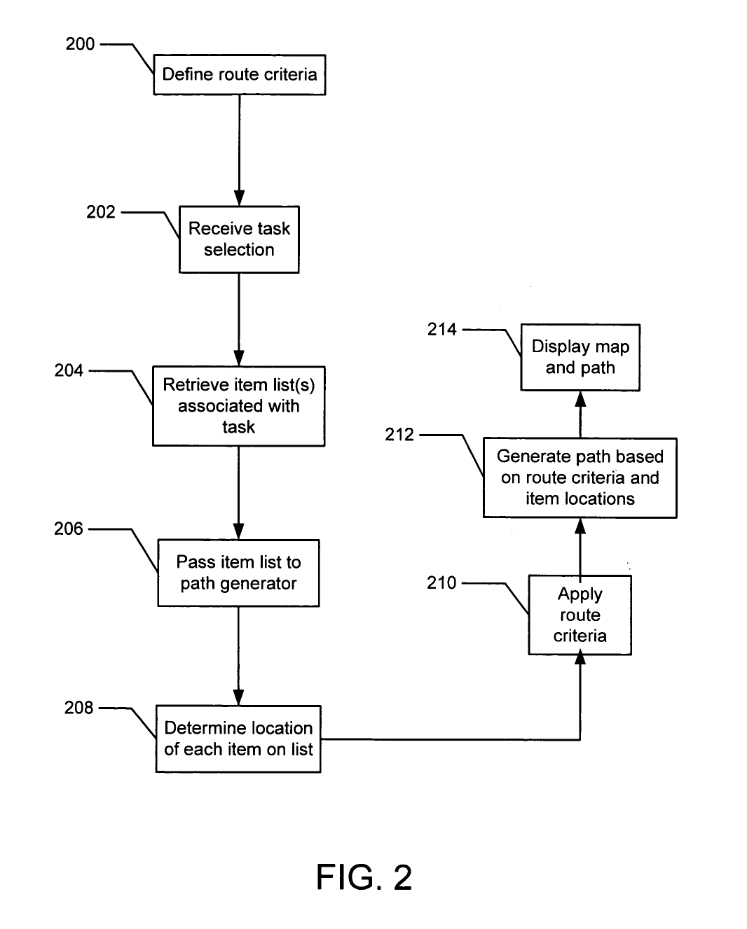

FIG. 2 is a flowchart illustrating a process for providing a path through a store to at least one item associated with a task according to a preferred embodiment of the present invention. Referring to FIG. 1 and FIG. 2, the process begins by defining the route criteria 45 in the path generator 44 (step 200). This step is preferably performed by the store administrator, although the shopper can also be allowed to define the route criteria 45.

Next, a task selection is received by the client device 20 (step 202). In a preferred embodiment, the client device 20 provides a user interface that allows the shopper to specify the task.

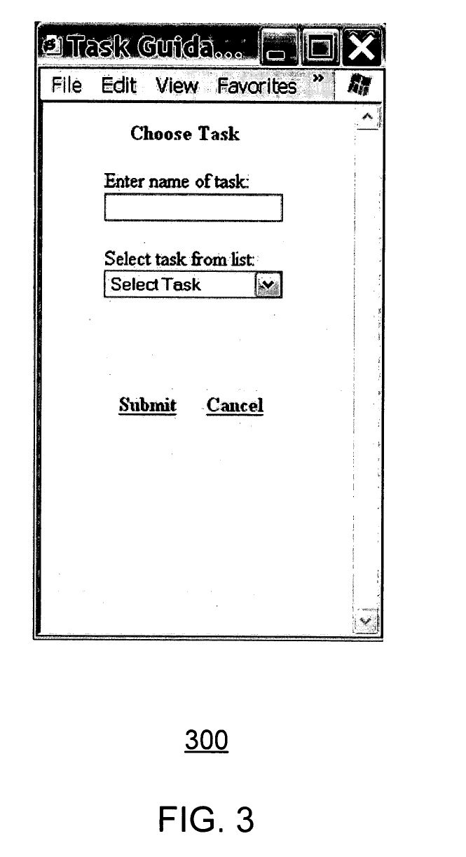

FIG. 3 is an exemplary window 300 through which the shopper specifies the task according to a preferred embodiment of the present invention. As is shown, the shopper can either type in a description or name of the task, or select the task from a drop-down menu. While the tasks are generally provided by the store 10, the shopper may be allowed to define a customized task before traveling to the store 10 using a home computer system coupled to the store 10 via the Internet. When the shopper arrives at the store 10, the customized task can be presented to the shopper for selection. By selecting the “submit” button, the shopper directs the client device 20 to transmit the task to the task mapper 42 in the server 40.

Once the task mapper 42 receives the task from the client device 20, it retrieves from the database 50 the item list(s) 52 associated with the task (step 204). If the task is associated with only one item list 52, then the task mapper 42 passes the list 52 to the path generator 44 (step 206). Otherwise, the task mapper 42 can return the item lists 52 to the shopper and allow the shopper to select one list 52, or the mapper 42 can pass each list 52 to the path generator 44 for processing.

In any event, after the path generator 44 receives the item list 52, it analyzes each item on the list 52 and determines a location associated with each the item (step 208) by retrieving location information 57 from the database 50. Next, the path generator 44 applies the route criteria 45 defined previously (step 210). Based on the route criteria 45 and the location of each item, the path generator 44 generates a path from a starting point through the location of each item (step 212), and displays to the shopper a map that includes a store layout and the path (step 214).

In one embodiment, the map displays a portion of the path that starts from a starting point (current location) and ends at the location of one specific item on the list 52. The map is then updated to display another portion of the path when the shopper retrieves the item and is ready to locate another item on the list 52. This embodiment is preferable if the client device is a portable mobile device carried by the shopper.

In another embodiment, the map displays the entire path that includes each of the list items. This embodiment is preferable if the client device is stationary and printing the map is desirable.

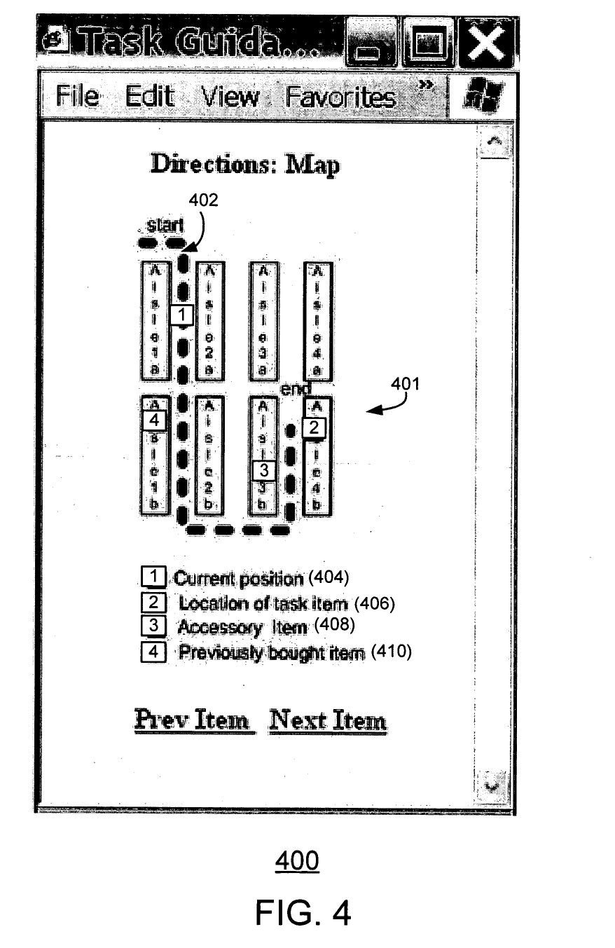

FIG. 4 is an exemplary diagram of the map displayed to the shopper according to a preferred embodiment of the present invention. Here, the map 400 depicts a portion of a path 402 that starts from a starting point and ends at a location of a specific item on the list 52.

As is shown, the store layout 410 comprises two rows of four aisles. The path 402 is represented by a dashed line; and icons 406, 408, 410 represent points of interest. Notably, while the path 402 begins at an end of aisle 1a (60a) and terminates at a location of the item 406, the path 402 is not the shortest one to the item 406. Rather, the path 402 leads the shopper past other products of interest, such as a previously bought item 410 and an accessory item 408.

In the example of FIG. 4, the route criteria 45 includes directing the path generator 44 to consider the shopper's previous purchases and accessories to the task item 406. When such products are identified and located in the vicinity of the task item 406, the path generator 44 incorporates those products into the path 402.

The shopper can select any of the icons 406, 408, 410 at any time to display the name of the item 406 or product 408, 410, its price, and other related information. In addition, a picture of the item 406 or product 408, 410 can be displayed to the shopper so that the shopper can easily identify the item 406 or product 408, 410 by sight.

In a preferred embodiment, the map 400 changes to reflect the shopper's movement through the store 10. Thus, the icon representing the current position 404 tracks the movement of the shopper. This tracking can be accomplished through a number of methods. For instance, if the client device 20 is a portable mobile device carried by the shopper or attached to the shopping cart 22, the location of the client device 20 can be tracked via triangulation methods or the like. Alternatively, the shopping cart 22 can include a radio frequency identifier (RFID) tag 24 that transmits a signal to one of several RFID sensors 26 installed on each aisle 60 when the shopping cart 22 is within a certain range of the sensor 26. Those skilled in the art would readily appreciate that other methods of tracking exist and that the present invention is not limited to those discussed above.

In a preferred embodiment, as the shopper approaches an icon representing a point of interest 406, 408, 410, a new image is automatically displayed showing the elevation view of the shelf containing the item 406 or product 408, 410 and its exact location highlighted on the shelf. In addition, an indicator on the shelf containing the item 406 or product 408, 410 can notify the shopper that the shopper is approaching the item 406 or product 408, 410. The indicator can be a visual indicator or an audio indicator.

When the shopper reaches the end of the path 406 and locates the task item, the shopper can retrieve the item and continue shopping by selecting a next or previous item on the list 52. In response, the map 400 is updated to display another portion of the path starting from the shopper's current position and ending at the location of the selected item on the list 52.

Alternatively, if the shopper does not want to purchase the item on the list 52, the shopper can request an alternate or equivalent product and a map 400 to the alternate product, if available, will be displayed to the shopper. Preferably, the shopper is allowed to select an alternate item list 52 or to choose substitute items at any time.

In a preferred embodiment, if the shopper determines that an item retrieved is no longer needed and wishes to return the item, a map showing the shopper where to return the unwanted item(s) can be displayed to the shopper. Accordingly, the store shelves can remain organized and efforts to reshelve unwanted merchandise is reduced.

While the map 400 illustrated in FIG. 4 depicts the points of interest 404-410 as numbered icons, alternate ways of depicting the points of interest 404-410 are also possible. For instance, instead of numbered icons, each icon can be depicted by a different color, or by different shapes.

Moreover, while the path generator 44 preferably generates a map 400 that graphically depicts the store layout 401 and the path 402, various modes of presenting the path 402 are available. For example, the path 402 can be described by text and images, or displayed using 3-dimensional perspective motion animation. Such modes would be apparent to those skilled in the art.

Referring again to FIG. 2, after the task mapper 42 passes the item list 52 to the path generator 44 (step 206), the path generator 44 determines the location of each item on the list 52 (step 208), applies the route criteria 45 (step 210) and proceeds to create the path (step 212). If, however, an item on the list 52 is unavailable, for example because the store does not stock the item or because the item is out of stock, the path generator 44 provides additional support to the shopper by providing information regarding different stores where the item may be purchased.

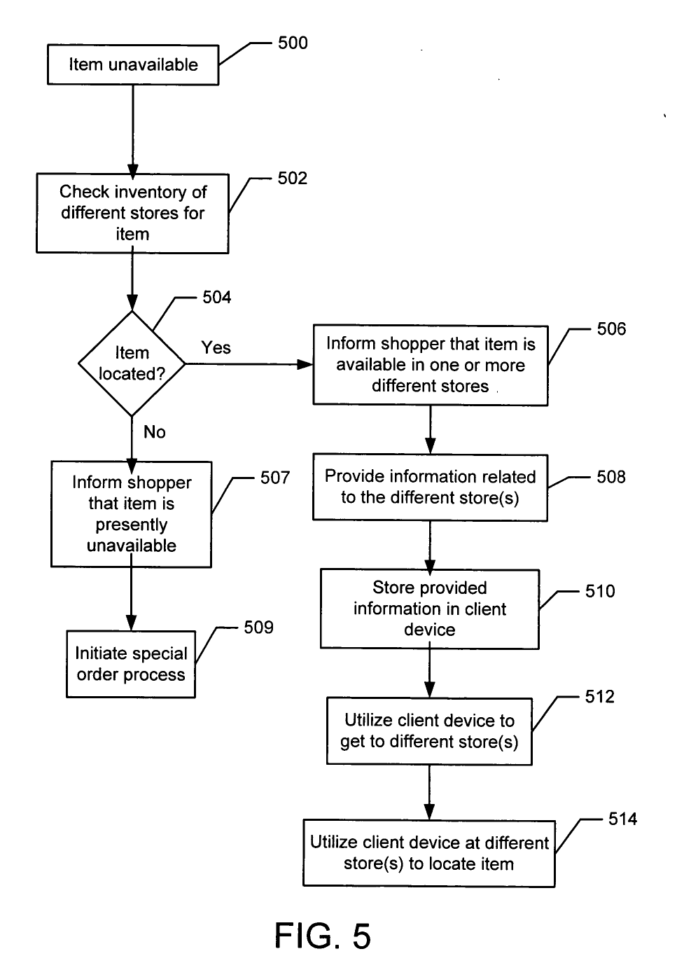

FIG. 5 is a flowchart illustrating a process for managing an item that is unavailable in a store according to a preferred embodiment of the present invention. Referring to FIG. 1 and FIG. 5, the process begins when the path generator 44 determines that an item is unavailable in the store (step 500). The path generator 44 determines this by either failing to retrieve location information 57 associated with the item or by checking the store inventory 55 and determining that the item is out of stock. When an item is unavailable, the path generator 44 proceeds by checking the inventory of different stores 54 for the item (step 502). In a preferred embodiment, the different stores can be affiliated with the store 10 or they can be stores that pay a fee to be the store's secondary supplier.

If the item is not located in any of the stores (step 504), the path generator 44 informs the shopper that the item is presently unavailable (step 507). In a preferred embodiment, the shopper can then be allowed to special order the item (step 509).

If the item is located in one or more different stores (step 504), the path generator 44 informs the shopper that the item can be found in one or more different stores (step 506) and provides information related to the different store(s) (step 508).

In a preferred embodiment, the information related to the different store can include the store's physical address, its phone number, directions to the store, as well as, information about the layout of the store. In addition, if the different store is an online store, i.e., a virtual store, the information can include the store's URL. If the client device 20 is owned by the shopper, the information related to the different store(s) is stored in the device 20 (step 510). Otherwise, the information can be printed out at the store 10 and provided to the shopper.

If the client device 20 is owned by the shopper, the shopper utilizes the client device 20 to get to the different store(s) (step 512). In a preferred embodiment, the client device 20 is enabled to communicate with a navigation system in a vehicle, e.g., via a blue tooth protocol or IRDA, where the navigation system and client device 20 utilize compatible application interface and service method definitions, e.g., via Web Services techniques. Alternatively, the client device 20 can communicate an audio announcement of the store address to a navigation system in the vehicle equipped to accept voice commands. Moreover, the client device 20 itself can be equipped with the navigation system. When the shopper enters the vehicle equipped with the navigation system, the client device 20 transmits to the navigation system the different store's address, and the navigation system then guides the shopper to the different store.

Once the shopper gets to the desired different store, the shopper utilizes the client device 20 to locate the item (step 514). For example, the shopper can access from the client device 20 the information related to the store that preferably includes the store's layout, utilize the client device 20 to communicate with the different store's server, if the different store is so configured, or simply ask an employee for assistance.

In another preferred embodiment, an application service provider (ASP) provides the path generation service through a central server accessible over the Internet. Through this embodiment, a store's database 50 is not required to store the inventories of other stores 54 as well as other data needed to generate the path. Moreover, the path generation process can be initiated from a location convenient to the shopper via the Internet, rather than in the actual store 10.

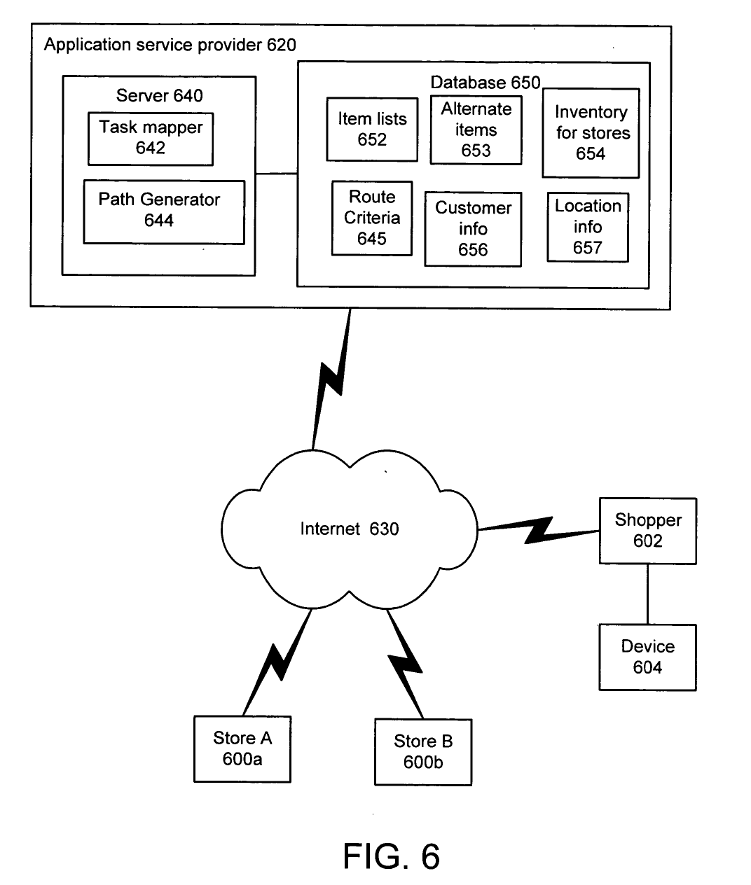

FIG. 6 is a block diagram illustrating a network environment according to this preferred embodiment of the present invention. Here, retail stores 600a, 600b and a shopper's web-enabled computer system 602 are able to access the ASP 620 via a public network such as the Internet 630. While the web-enabled computer system 602 is typically a personal computer, it can also be a portable electronic device, such as a PDA or mobile phone.

In the preferred embodiment, a store, e.g., 600a subscribes to the ASP 620 by providing information related to the store 600a. Such information includes store inventory 654, store layout and location information 657, and a route criteria 645. This information is then stored in a database 650 coupled to a server 640 associated with the ASP 620.

The server 640, like the server 40 in a store 10 (FIG. 1), includes the task mapper 642 and the path generator 644. In a preferred embodiment, the shopper can utilize the computer system 602 at home (or anywhere else, e.g., a library or Internet café) to access the ASP server 640 via the Internet 630 and specify a task the shopper wishes to perform. The task mapper 642 retrieves the associated item list(s) 652 and submits each to the generator 644, which generates a path based on the location of each item on a list 652 and the route criteria 645 of one or more stores 600a, 600b.

In a preferred embodiment, the path can also be based on other factors that are relevant to the shopper. For example, if cost is a primary concern for the shopper, the generator 644 will compare the cost of an item at each of the stores 600a, 600b and choose the store that has the item for the lowest cost. If convenience is of primary concern for the shopper, the generator 644 will identify the store 600b that stocks most, if not all, of the items so that the shopper can purchase all of the items in one store. Thus, the shopper can indicate his or her preferences, and the generator 644 can create a path that takes into consideration those preferences.

The path generator 644 provides a map that includes the path through at least one store to items associated with the task. The map can be returned to the shopper's computer system 602, where it can be downloaded onto and stored on a portable device 604 owned by the shopper or printed on a local printer. Alternatively, the map can be transmitted directly to the portable device 604. The shopper can then carry the portable device 604 to the store 600a, and utilize the map stored in the portable device 604 to locate the items associated with the task.

In a preferred embodiment, the store 600a is a store described in FIG. 1. Accordingly, the portable device 604 can communicate with the store's server 40 and the map displayed to the shopper can be updated on-the-fly. In addition, the store's wireless network 30 is coupled to the Internet 630 so that the ASP 620 is able to reach the store's 600a RFID/triangulation capability, and to synchronize the information in the database 650 with the store's information, e.g., inventory, location, etc.

The present invention provides a method and system for providing a path through at least one store to items associated with a task. The path of the present invention is based not only on the store layout and the location of the items associated with the task, but also on other independent factors or criteria, such as, for example, the shopper's historical purchasing patterns, the store's inventory, the location of related items, accessory or alternative items, and sale items. Thus, the path leads the shopper to the items associated with the task as well as other products that may be of interest to the shopper.

The present invention has been described in accordance with the embodiments shown, and one of ordinary skill in the art will readily recognize that there could be variations to the embodiments. Any variations would be within the spirit and scope of the present invention. Accordingly, many modifications may be made by one of ordinary skill in the art without departing from the spirit and scope of the appended claims.

What is claimed is:

1. A method for providing a path through at least one store to at least one item associated with a task, comprising:
defining a route criteria that identifies other products that may be of interest to a shopper;
determining a location associated with each of the at least one items associated with the task; and
generating a path based on each location and the route criteria,
wherein the path leads the shopper to each location and past the other products of interest.

2. The method of claim 1, wherein the route criteria is based on one or a combination of the following: an accessory to the at least one item, the shopper's purchasing history, the store's inventory and discounted products.

3. The method of claim 1 further including displaying a map to the shopper, wherein the map includes a store layout, the path beginning from a starting point in the store layout and leading to the location of at least one item, an icon corresponding to the location of the at least one item, and an icon corresponding to the location of each product of interest along the path.

4. The method of claim 1 further comprising:
allowing the shopper to specify the task via an electronic device;
retrieving from a database at least one item list associated with the specified task;
displaying the at least one item list to the shopper on a display in the electronic device; and
allowing the shopper to choose one of the item lists based on the shopper's budget, the shopper's skill level, or both.

5. The method of claim 4 further comprising:
determining whether each item on the chosen item list is available in the store; and
if an item is not available, suggesting an alternative item that is available in the store.

6. The method of claim 1 further comprising:
determining whether each of the at least one items associated with the task is available in the store; and
if an item is not available in the store, retrieving information related to at least one different store where the item is available.

7. The method of claim 6, wherein retrieving information includes retrieving addresses and directions to each of the at least one different stores.

8. The method of claim 7 further comprising:
transmitting to the electronic device the information related to the at least one different stores; and
displaying the information to the shopper.

9. The method of claim 8 wherein the electronic device is a portable device that is capable of communicating with a navigation system in a vehicle, the method further comprising:
storing in the electronic device the related information;
allowing the shopper to select one of the at least one different stores; and
transmitting the address of the selected different store from the electronic device to the navigation system in the vehicle.

10. The method of claim 8, wherein the electronic device is a portable device, the method further comprising:
storing in the electronic device the related information;
allowing the shopper to select one of the at least one different stores; and
utilizing the portable electronic device at the selected different store to automatically locate the item.

11. A computer readable medium containing programming instructions for providing a path through at least one store to at least one item associated with a task, comprising:
defining a route criteria that identifies other products that may be of interest to a shopper;
determining a location associated with each of the at least one items associated with the task; and
generating a path based on each location and the route criteria,
wherein the path leads the shopper to each location and past the other products of interest.

12. The computer readable medium of claim 11, wherein the route criteria is based on one or a combination of the following: an accessory to the at least one item, the shopper's purchasing history, the store's inventory and discounted products.

13. The computer readable medium of claim 11 further including displaying a map to the shopper, wherein the map includes a store layout, the path beginning from a starting point in the store layout and leading to the location of at least one item, an icon corresponding to the location of the at least one item, and an icon corresponding to the location of each product of interest along the path.

14. The computer readable medium of claim 11 further comprising:
allowing the shopper to specify the task via an electronic device;
retrieving from a database at least one item list associated with the specified task;
displaying the at least one item list to the shopper on a display in the electronic device; and
allowing the shopper to choose one of the item lists based on the shopper's budget, the shopper's skill level, or both.

15. The computer readable medium of claim 14 further comprising:
determining whether each item on the chosen item list is available in the store; and
if an item is not available, suggesting an alternative item that is available in the store.

16. The computer readable medium of claim 11 further comprising:
determining whether each of the at least one items associated with the task is available in the store; and
if an item is not available in the store, retrieving information related to at least one different store where the item is available.

17. The computer readable medium of claim 16, wherein retrieving information includes retrieving addresses and directions to each of the at least one different stores.

18. The computer readable medium of claim 17 further comprising:
transmitting to the electronic device the information related to the at least one different stores; and
displaying the information to the shopper.

19. The computer readable medium of claim 18 wherein the electronic device is a portable device that is capable of communicating with a navigation system in a vehicle, the instructions further comprising:
storing in the electronic device the related information;
allowing the shopper to select one of the at least one different stores; and
automatically transmitting the address of the selected different store from the electronic device to the navigation system in the vehicle.

20. The computer readable medium of claim 18, wherein the electronic device is a portable device, further comprising:
storing in the electronic device the related information;
allowing the shopper to select one of the at least one different stores; and
utilizing the portable electronic device at the selected different store to automatically locate the item.

21. A retail store comprising a plurality of items and products for purchase, the store comprising:
a server for providing a path through the retail store to at least one item associated with a task;
a database coupled to the server for storing information related to a plurality of tasks and information related to the retail store; and
means for defining a route criteria that identifies other products that may be of interest to a shopper,
wherein the server accesses the database to determine a location associated with each of the at least one items associated with the task and generates the path based on each location and the route criteria such that the path leads the shopper to each of the at least one items and past the other products of interest.

22. The retail store of claim 21 further comprising at least one electronic device in communication with the server via a network, wherein the at least one electronic device includes a display for displaying a map to the shopper, wherein the map includes a store layout, the path beginning from a starting point in the store layout and leading to the location of at least one item, an icon corresponding to the location of the at least one item, and an icon corresponding to the location of each product of interest along the path.

23. The retail store of claim 22, wherein the electronic device further includes a user interface for allowing the shopper to specify the task and means for transmitting the specified task to the server, wherein in response to receiving the specified task, the server retrieves from the database at least one item list associated with the specified task and returns the at least one item list to the electronic device.

24. The store of claim 23, wherein the electronic device displays the at least one item list to the shopper and allows the shopper to choose one of the item lists based on the shopper's budget, the shopper's skill level, or both.

25. The store of claim 21, wherein the server determines whether each of the at least one items associated with the task is available in the store and if an item is not available, suggests an alternative item that is available in the store.

26. The store of claim 21, wherein the server determines whether each of the at least one items associated with the task is available in the store and if an item is not available in the store, the server retrieves from the database information related to at least one different store where the item is available.

27. The store of claim 26, wherein the related information includes addresses and directions to each of the at least one different stores.

28. The store of claim 27, wherein the server transmits to the electronic device the information related to the at least one different stores and the information is displayed to the shopper.

29. The store of claim 28, wherein the electronic device is a portable device that is capable of communicating with a navigation system in a vehicle, and the electronic device stores the related information, allows the shopper to select one of the at least one different stores, and automatically transmits the address of the selected different store to the navigation system in the vehicle.

30. The retail store of claim 28, wherein the electronic device is a portable device, and the electronic device stores the related information, allows the shopper to select one of the at least one different stores, and is utilized at the selected different store to automatically locate the item.

31. An electronic device comprising:
means for communicating with a server in a store over a wireless network;
a user interface for allowing a shopper to select a task the shopper wishes to perform; and
a display for displaying a response from the server,
wherein the server determines a location associated with at least one item associated with the selected task, generates a path based on each location and on a route criteria that identifies other products of interest, such that the path leads the shopper to each of the at least one items and past other products of interest; and returns a map including the path to the electronic device.

32. The electronic device of claim 31, wherein the map includes a store layout, the path beginning from a starting point in the store layout and leading to the location of at least one item, an icon corresponding to the location of the at least one item, and an icon corresponding to the location of each product of interest along the path.

33. The electronic device of claim 31, wherein the electronic device is coupled to a printer that allows the shopper to print the map.

34. The electronic device of claim 31, wherein the server determines whether the at least one item is available in the store and if the item is not available, retrieves information related to at least one different store where the item is available, and returns to the electronic device the related information where it is displayed to the shopper.

35. The device of claim 34, wherein the electronic device is a portable mobile device that stores the related information, allows the shopper to select one of the at least one different stores, and is utilized at the selected different store to automatically locate the item.

36. The device of claim 34, wherein the electronic device is a portable device that is capable of communicating with a navigation system in a vehicle, and the electronic device stores the related information, allows the shopper to select one of the at least one different stores, and automatically transmits an address of the selected different store to the navigation system in the vehicle.

37. An application service provider for providing a path through at least one the retail store to at least one item associated with a task comprising:
a server;
a database coupled to the server for storing information related to a plurality of tasks and information related to the at least one retail store; and
means for defining a route criteria for each of the at least one stores that identifies other products in a store that may be of interest to a shopper,
wherein the server accesses the database to determine a location associated with each of the at least one items associated with the task and generates a map that includes the path based on each location and a route criteria associated with the location such that the path leads the shopper to each of the at least one items in at least one store and past the other products of interest.

38. The application service provider of claim 37, wherein the server is coupled via an Internet to a computer system used by a shopper and the server returns the map to the computer system.

39. The application service provider of claim 38, wherein the computer system is a portable electronic device.
